(19) United States
(12) Patent Application Publication
(10) Pub. No.: US 2012/0187598 A1
(43) Pub. Date: Jul. 26, 2012

(54) METHOD AND APPARATUS OF COMPRESSION MOLDING TO REDUCE VOIDS IN MOLDING COMPOUNDS OF SEMICONDUCTOR PACKAGES

(76) Inventors: Kuo-Yuan LEE, Kaohsiung (TW); Yung-Hsiang Chen, Kaohsiung (TW)

(21) Appl. No.: 13/214,459

(22) Filed: Aug. 22, 2011

(30) Foreign Application Priority Data
Jan. 20, 2011 (TW) 100102181

(51) Int. Cl. B29C 43/18

(52) U.S. Cl. 264/272.15; 425/73

(57) ABSTRACT

Disclosed are a method and an apparatus of compression molding to reduce voids in molding compounds of semiconductor packages. A compression mold jig set including a top mold and a bottom mold is provided and disposed inside a pressure chamber. A substrate disposed with chips is loaded on the top mold. An encapsulating material is filled in the cavity of the bottom mold. When heating the bottom mold to melt the encapsulating material, a positive air pressure more than 1 atm is provided in the pressure chamber in order to expel or reduce any bubbles trapped inside the encapsulating material. Then, the top mold is pressed downward to clamp with the bottom mold under the heating and high-pressure condition until the encapsulating material is pre-cured to transform a molding compound adhered to the substrate. Therefore, potential bubble trapped inside the molding compound can be eliminated or reduced to improve production yield, reliability and life time.

### FIELD OF THE INVENTION

The present invention relates to a packaging methodology of semiconductor devices, and more specifically to a method and an apparatus of compression molding to reduce voids in molding compounds of semiconductor packages.

### BACKGROUND OF THE INVENTION

According to the convention semiconductor packaging technology, a plurality of semiconductor chips are disposed in an array with constant spacing and pitches on a substrate. After processes of electrical connection between the chips and the substrate, encapsulating materials are formed on top of the substrate to encapsulate the chips. Then, the molding compound cured from the encapsulating materials is singulated by a dicing blade or by a laser to obtain a plurality of individual semiconductor devices.

In order to enhance the quality of molding compounds of advanced packages to ensure product reliability and to increase productivity, compression molding technology is recently developed to replace the conventional transfer molding where molding compounds are melted to encapsulate the chips under specific mold pressures to eliminate the usage of encapsulating material for runners. However, during the heating and cooling processes of compression molding technology, solid or paste encapsulating materials were melted and cured during curing processes, bubbles trapped in encapsulating materials or gases reacted and released during curing processes would cause voids in the cured molding compound which reduces mechanical strengths of the products or product weights specified by customers. Moreover, when bubbles trapped or voids formed in the molding compound, delamination or pop corn easily occurs between chips and substrates during thermal cycles leading to product reliability issues.

As disclosed in U.S. Pat. No. 7,157,311 B2, Meguro et al. taught a molding method using a substrate sheet material. A molding process integrated compression molding and vacuum molding is revealed where vacuum is implemented before the joint of top mold and bottom mold to avoid bubbles entrapped in molding compounds of semiconductor packages. However, the bubbles originally trapped in encapsulating materials can not be expelled during heating or cooling cycles of curing processes which may lead to void expansion caused bubbles trapped in molding compounds.

### SUMMARY OF THE INVENTION

The main purpose of the present invention is to provide a method and an apparatus of compression molding to reduce voids in molding compounds of semiconductor packages. Potential bubbles trapped in molding compounds are expelled or reduced to enhance product yield, reliability, and lifetime.

The second purpose of the present invention is to provide a method and an apparatus of compression molding to reduce voids in molding compounds of semiconductor packages. Delamination or pop corn between chips and substrates caused in conventional compression molding is avoided due to expansion under thermal cycles.

According to the present invention, a method of compression molding to reduce voids in molding compounds of semiconductor packages is revealed. Firstly, a compression mold set is provided in the pressure chamber. The compression mold jig set includes a first top mold and a first bottom mold installed below the first top mold where the first bottom mold has a first mold cavity. Then, a first substrate is loaded on the first top mold where a plurality of first chips are mechanically disposed on and electrically connected to the first substrate. A first encapsulating material is filled into the first mold cavity. Then, the first bottom mold is heated to melt the first encapsulating material and a positive air pressure more than 1 atm is provided by the pressure chamber until expelling or reducing potential bubbles trapped in the first encapsulating material. Then, the first top mold is pressed downward under heating and continuously pressurizing condition until the first encapsulating material encapsulates the first chips and physically adheres to the substrate and the first encapsulating material is pre-cured to transform a molding compound adhered to the first substrate. The apparatus implemented in the afore described method is also revealed.

The method and apparatus of compression molding according to the present invention has the following advantages and effects:
1. Through a specific heating and pressurizing process sequence of curing molding compounds as a technical mean, a positive air pressure greater than 1 atm is provided in the pressure chamber in which a top mold and a bottom mold are disposed from filling to curing of the encapsulating material so that potential bubbles trapped in the encapsulating material are expelled or reduced to enhance product yield, reliability, and lifetime.
2. Through a specific heating and pressurizing process sequence of curing molding compounds as a technical mean, a positive air pressure greater than 1 atm is provided in the pressure chamber in which a top mold and a bottom mold are placed from filling to curing of the encapsulating material to avoid delamination or pop corn between chips and substrates due to expansion under thermal cycles.
3. Through an interchangeable double loading/unloading carrier with a specific heating and pressurizing process sequence of curing molding compounds as a technical mean, two sets of top mold and bottom mold assemblies are simultaneously disposed in a chamber pressure exerted with an air pressure greater than 1 atm. The two sets of top mold and bottom mold assemblies have the asynchronous loading/unloading motions which can proceed with different processing steps through the interchangeable double-loading carrier to achieve economically expelling or reducing bubbles trapped in the encapsulating materials.

### DESCRIPTION OF THE DRAWINGS

FIGS. 1A to 1F are cross-sectional component views illustrating a method of compression molding to reduce voids in molding compounds of semiconductor packages according to the first embodiment of the present invention.

FIGS. 2A to 2D are cross-sectional component views illustrating another method of compression molding to reduce voids in molding compounds of semiconductor packages according to the second embodiment of the present invention.

FIG. 3 is an equipment block diagram for implementing in the method of FIGS. 2A-2D according to the second embodiment of the present invention.

FIG. 4 is a process flow diagram of a semiconductor packaging method including the compression molding method according to the present invention.

### DETAILED DESCRIPTION OF THE INVENTION

With reference to the attached drawings, the present invention is described by means of the embodiment(s) below where the attached drawings are simplified for illustration purposes only to illustrate the structures or methods of the present invention by describing the relationships between the components and assembly in the present invention. Therefore, the components shown in the figures are not expressed with the actual numbers, actual shapes, actual dimensions, nor with the actual ratio. Some of the dimensions or dimension ratios have been enlarged or simplified to provide a better illustration. The actual numbers, actual shapes, or actual dimension ratios can be selectively designed and disposed and the detail component layouts may be more complicated.

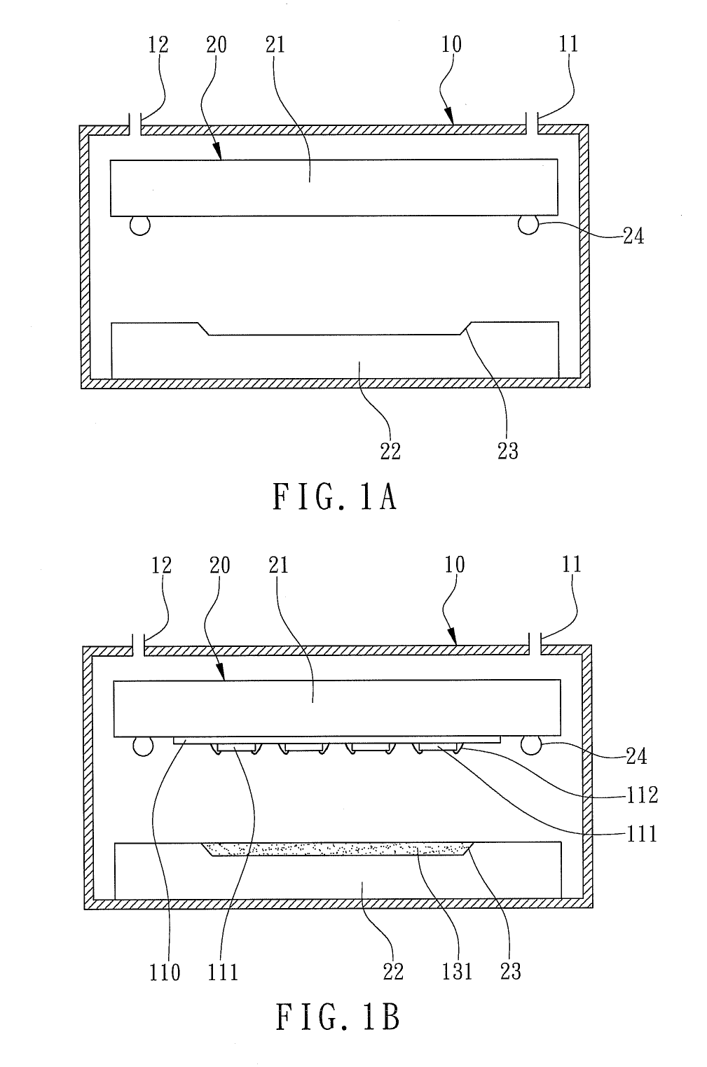

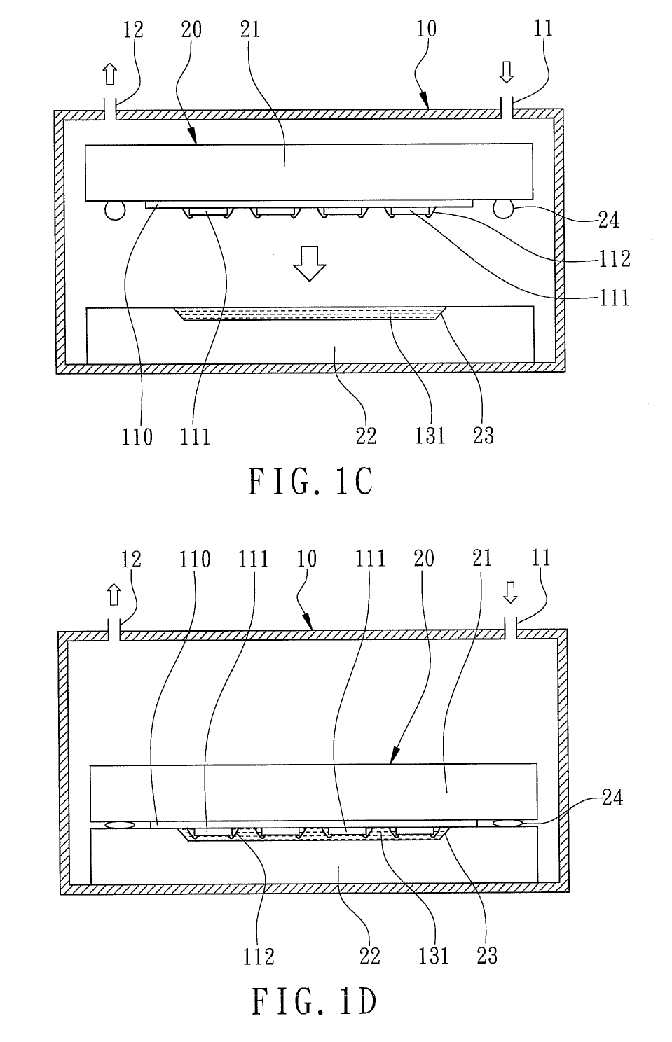

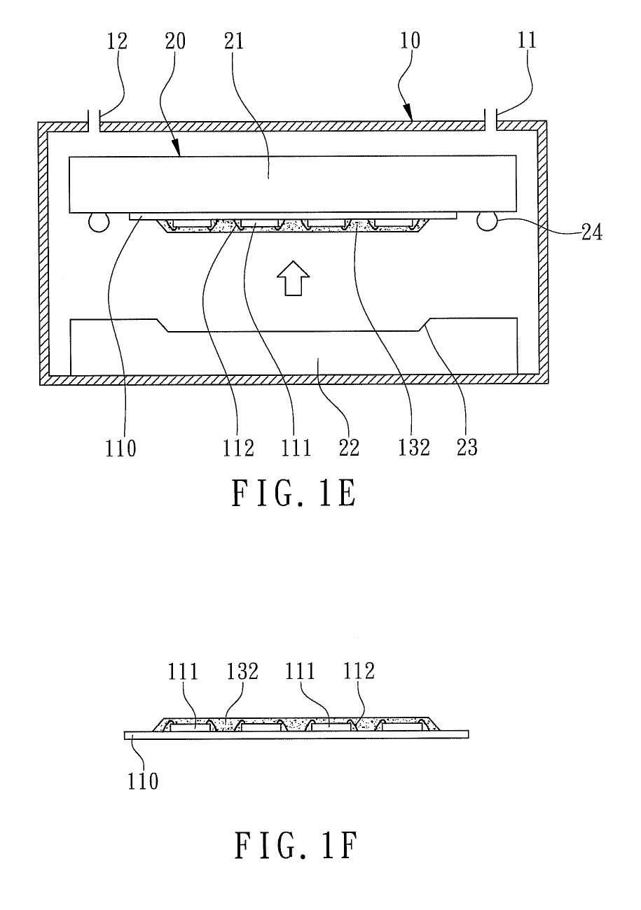

According to the first preferred embodiment of the present invention, a method of compression molding to reduce voids in molding compounds of semiconductor packages is revealed where cross-sectional component views during the method are illustrated from FIG. 1A to FIG. 1F which are described in detail as follows.

Firstly, as shown in FIG. 1A, a compression mold jig set 20 is provided and disposed inside a pressure chamber 10 having an oven function. The compression mold jig set 20 includes a first top mold 21 and a first bottom mold 22 installed below the first top mold 21 where the first bottom mold 22 has a first mold cavity 23. The first top mold 21 and the first bottom mold 22 are made of metal and disposed in the pressure chamber 10. The first mold cavity 23 is designed according to the dimensions and numbers and arrangement of mold areas and mold thickness formed on top of a substrate.

Then, as shown in FIG. 1B, the first substrate 110 is loaded on the first top mold 21 with the mold area of the first substrate 110 facing downward and aligned to the first mold cavity 23 of the first bottom mold 22. The chamber pressure inside the pressure chamber 10 is a positive air pressure greater than 1 atm. Before loading the first substrate 110, a plurality of first chips 111 are physically disposed on and electrically connected to the first substrate 110. To be more specific, the first substrate 110 can be a printed circuit board, a leadframe, a circuit film or other chip carriers. Normally, the first substrate 110 is designed in strip form for mass production. The first chips 111 are disposed on the top surface of the first substrate 110 followed by electrical connections between the first chips 111 and the substrate 110 by wire bonding or by flip chip bonding. In the present embodiment, the first chips 111 are electrically connected to the first substrate 110 by a plurality of first bonding wires 112 where the first bonding wires 112 are made of gold, copper, aluminum, or alloy. For those who are skilled in the art can change the configuration according to the actual semiconductor devices and requirements to increase the numbers of stacked chips and/or to implement Tape Automated Bonding (TAB) to replace wire bonding for electrical connection or other alternatives.

As shown in FIG. 1B again, A first encapsulating material 131 is filled into the first mold cavity 23 where the primary material of the first encapsulating material 131 can be a specific chemical formulation for specific requirements of semiconductor devices comprising thermal-setting resin and fillers. The first encapsulating material 131 can have a form of powder, pellet, or paste when filling into the first mold cavity 23.

Then, as shown in FIG. 1C, the first bottom mold 22 is heated to melt the first encapsulating material 131. At the same time, a positive air pressure greater than 1 atm is provided by the pressure chamber 10 until expelling or reducing potential bubbles trapped inside the first encapsulating material 131 to enhance package yield, reliability, and lifetime. The “atm” stands for atmospheric pressure. To be more specific, the positive air pressure in the pressure chamber ranges between 1 atm to 8 atm and the pressure chamber is continuously pressurized and exhausted. When the positive air pressure is stabilized, the volumes of the bubbles trapped inside the encapsulating material 131 can be reduced or even vanished due to the higher chamber pressure so that voids in molding compounds of semiconductor packages also can be reduced. To be described in more detail, the pressure chamber 10 can be set and kept in a specific chamber temperature with a specific chamber pressure where the pressure chamber 10 has a pressure inlet 11 and an exhaust outlet 12 so that heat and air pressure are continuously exerted on the first encapsulating material 131 after the first encapsulating material 131 is filled into the first mold cavity 23. When the temperature of the pressure chamber 10 continues to rise, the first encapsulating material 131 then is melt and become fluid. Since gases are continuously pumped into the pressure chamber 10 through pressure inlet 11, any bad atmosphere in the pressure chamber 10 is continuously exhausted with the positive air pressure, i.e., the exerted pressure from the pressure inlet 11 ranges from 1 to 7 Kg/cm² under 1 atm environment, so that the high temperature gases inside the pressure chamber 10 becomes high pressure fluid to expel or reduce the bubbles trapped or volatile solvent remained inside the first encapsulating material 131 where the volatile solvent can be exhausted from the exhausted outlet 12 to provide better atmosphere inside the pressure chamber 10. In more detail, the pressurized gases induced into the pressure chamber 10 through pressure inlet 11 can be dry air, N₂ or inert gases so that the bubbles trapped inside the first encapsulating material 131 can be expelled or reduced, moreover, the solvent remained in the melted first encapsulating material 131 and the moisture trapped in the packaging components such as chips or substrates can also be expelled. According to the processing sequence, the exhaust volume from the exhaust outlet 12 should be set to be smaller than the intake volume from the pressure inlet 11 to keep the positive air pressure inside the pressure chamber 10 to continuously expel or reduce the bubbles trapped inside the first encapsulating material 131.

Finally, as shown in FIG. 1C and FIG. 1D, the first top mold 21 is pressed downward under the heating and continuously pressurizing condition until the first encapsulating material 131 encapsulates the first chips 111 and physically adheres to the first substrate 110 and the first encapsulating material 131 is pre-cured into a molding compound 132 adhered to the first substrate 110 as shown in FIG. 1E. To be described in more detail, during the pre-curing process of the first encapsulating material 131, exhausting and pressurizing the pressure chamber 10 continues to keep chamber pressure between 1.8 atm and 8 atm with chamber temperature kept between 100° C. and 160° C. To be more specific, when the first top mold 21 is contacted and clamped with the first bottom mold 22, the melted first encapsulating material 131 encapsulates the first chips 111 and become semi-cured under specific heating conditions, i.e., the encapsulating material 131 is semi-cured under specific temperature and positive air pressure according to the material properties of the encapsulating material 131. Then, a post mold cure process is followed to make the molding compound 132 completely cured with excellent sealing, chemical stable, and good dielectric to protect the first chips 111 from external contamination and damage. After afore described processes with a chamber pressure more than 1 atm, potential bubbles trapped inside the first encapsulating material 131 can effectively be expelled or reduced so that delamination or pop corn of semiconductor devices can be avoided during thermal cycles to enhance the reliability of semiconductor devices.

Preferably, as shown in FIG. 1C and FIG. 1D, the first top mold 21 has a sealing ring 24 aligned around the first mold cavity 23 where the sealing ring 24 is elastic and heat-resistant to prevent bleeding of the first encapsulating material 131 when the first top mold 21 is pressed downward to clamp with the first bottom mold 22.

Furthermore, as shown in FIG. 1E and FIG. 1F, the afore described method of compression molding further comprises the following processing steps of: unloading the first substrate 110 from the first top mold 21 after the formation of the molding compound 132. After the cured molding compound 132 is formed, the first top mold 21 and the first bottom mold 22 are separated in order to remove the first substrate 110. After post mold curing processes, the molding compound 132 along with the first substrate 110 is cut by a dicing blade or a laser to obtain a plurality of individual semiconductor packages.

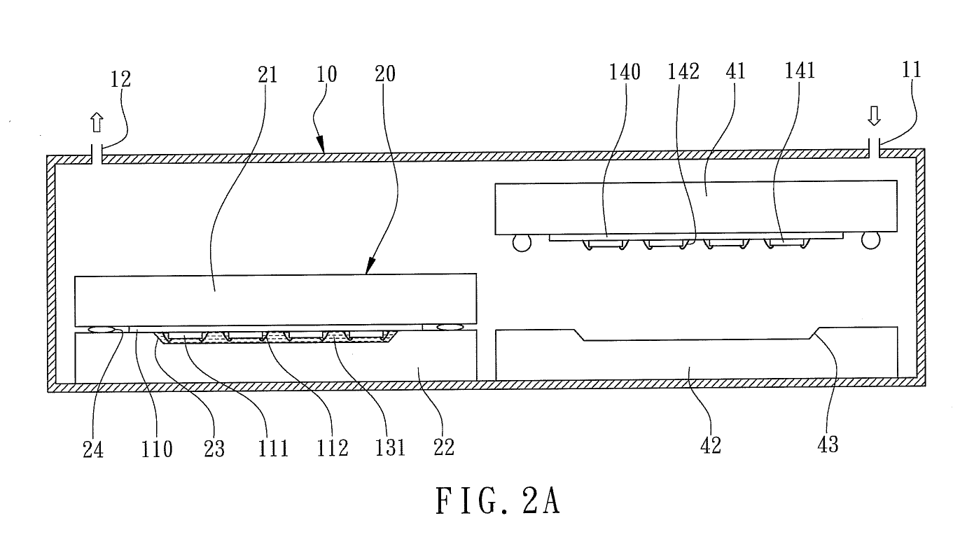

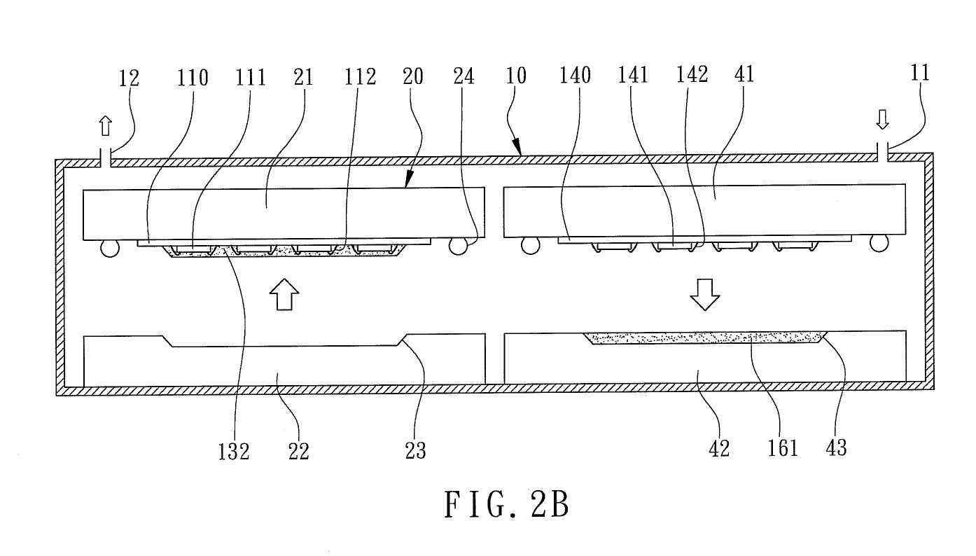

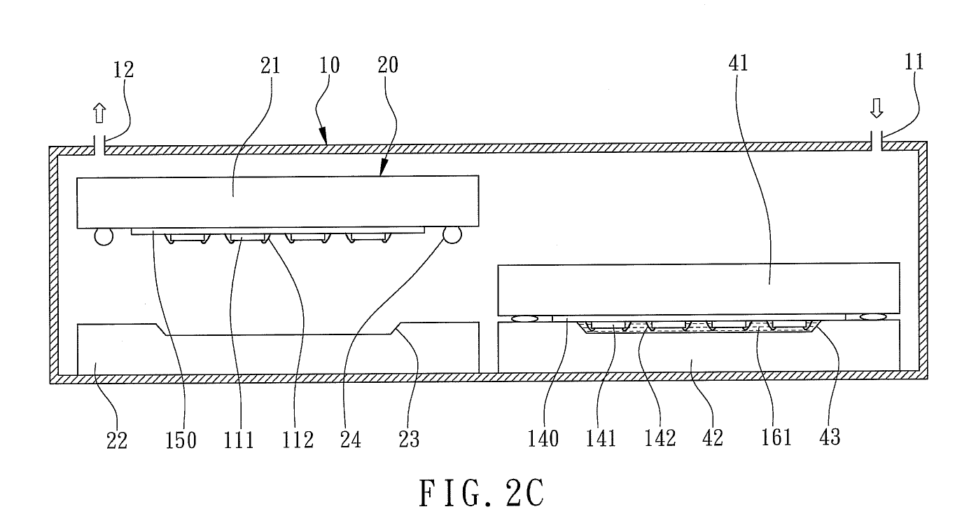

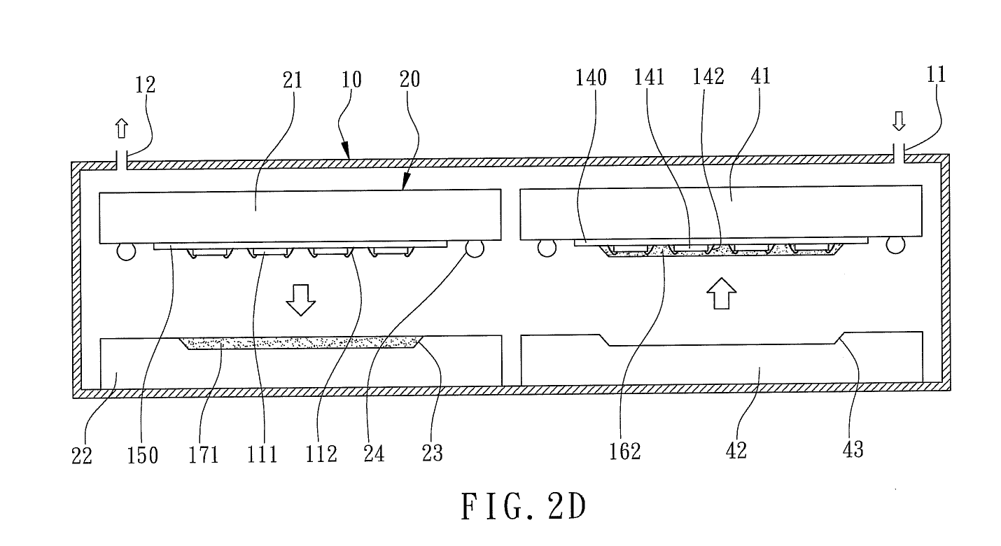

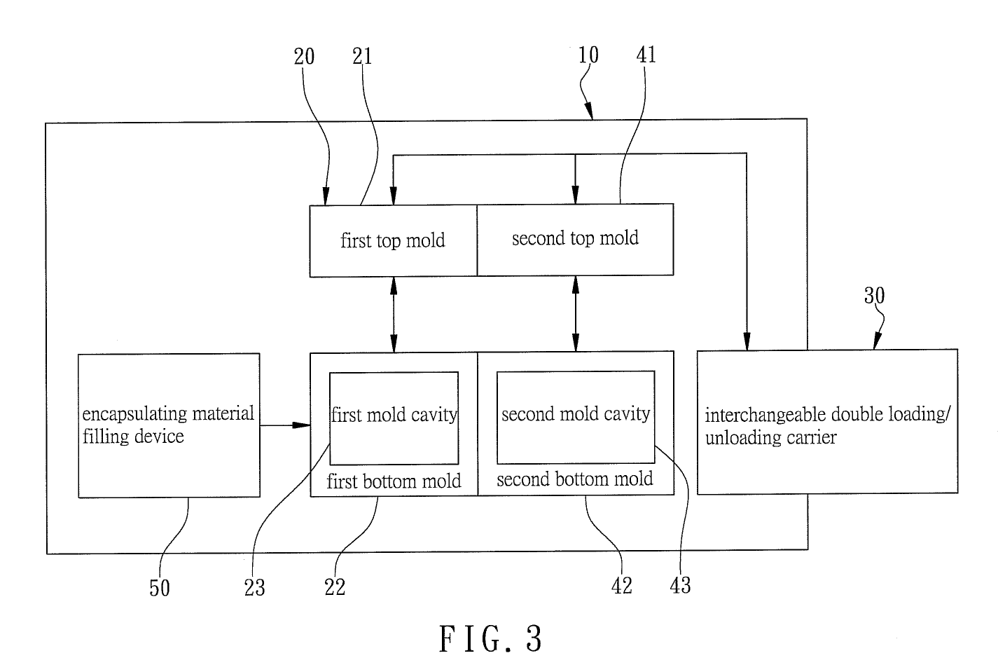

According to a second embodiment, as shown from FIG. 2A to FIG. 2D for cross-sectional component views illustrating important processing steps in the method and FIG. 3 for an equipment block diagram for implementing in the method. The method of compression molding to reduce voids in molding compounds of semiconductor packages includes afore described steps and further the steps as follows. An interchangeable double loading/unloading carrier 30 is provided as shown in FIG. 3. Additionally, the compression mold jig set 20 further includes a second top mold 41 for loading a second substrate 140 and a second bottom mold 42 installed below the second top mold 41 where the second bottom mold 42 has a second mold cavity 43. The second top mold 41 and the second bottom mold 42 can be the same as the first top mold 21 and the first bottom mold 22 for handling substrates with the same dimension and structure. But without limitation, substrates with different dimensions or substrate types can also be molded. In the present embodiment, the second substrate 140 is the same as the first substrate 110 with the same dimension and structure. Before loading the second substrate 140 on the second top mold 41, a plurality of second chips 141 are physically disposed on and electrically connected to the second substrate 140 where a plurality of second bonding wires 142 electrically connect the second chips 141 to the second substrate 140. When pressing down the second top mold 41, the molding area of the second substrate 140 is faced downward and aligned to the second mold cavity 43 of the second bottom mold 42. The first substrate 110 and the second substrate 140 are loaded and unloaded from the interchangeable double loading/unloading carrier 30 by the first top mold 21 and the second top mold 41 respectively. And the loading/unloading motions of the first top mold 21 and the second top mold 41 are asynchronous.

As shown in FIG. 2A, the second top mold 41 and the second bottom mold 42 are also disposed in the pressure chamber 10. The second substrate 140 is loaded on the second top mold 41 when the first encapsulating material 131 is pre-cured into the molding compound 132 in the first mold cavity 23 after the first top mold 21 is pressed down. The pressure chamber 10 also provides an operating sealing space with the positive pressure more than 1 atm between the second top mold 41 and the second bottom mold 42. Additionally, the interchangeable, double loading/unloading carrier 30 can move and rotate the substrates to proceed the asynchronous loading/unloading steps so that the first top mold 21 and the second top mold 41 can proceed with different processing steps. As shown in FIG. 2B, a second encapsulating material 161 is filled into the second mold cavity 43 after the formation of the molding compound 132. When unloading the first substrate 110 to separate from the first top mold 21, the second bottom mold 42 is heated to melt the second encapsulating material 161 under the heating and continuously pressurizing condition until expelling or reducing potential bubble trapped inside the second encapsulating material 161. The composition of the second encapsulating material 161 is the same as the one of the first encapsulating material 131. As shown in FIG. 3 again, the first encapsulating material and the second encapsulating material are filled into the first mold cavity 23 and the second mold cavity 43 respectively by an encapsulating material filling device 50 at different processing time.

Finally, as shown in FIG. 2C and FIG. 2D, the second top mold 41 is pressed downward to clamp with the second bottom mold 42 under the heating and continuously pressurizing condition until the second encapsulating material 161 is pre-cured into another molding compound 162. The molding compound 162 encapsulates the second chips 141 and physically adheres to the second substrate 140. Meanwhile, the first substrate 110 is unloaded from the first top mold 21 and then a third substrate 150 is loaded on the first top mold 21 from the interchangeable double loading/unloading carrier 30. After the formation of the molding compound 162, the second substrate 140 is unloaded form the second top mold 41, at the same time, a third encapsulating materials 171 is filled into the first mold cavity 23. By pressing down the first top mold 21 under the heating and continuously pressurizing condition again, the third encapsulating materials 171 is pre-cured into a molding compound adhered to the third substrate 150. Accordingly, two sets of top and bottom mold assembly are placed inside the pressure chamber 10 with the positive pressure greater than 1 atm to form the molding compounds 132 and 162. The interchangeable double loading/unloading carrier 30 enables two sets of top and bottom mold assembly to proceed different processing steps to achieve expelling or reducing voids trapped inside the encapsulating materials 131 and 161.

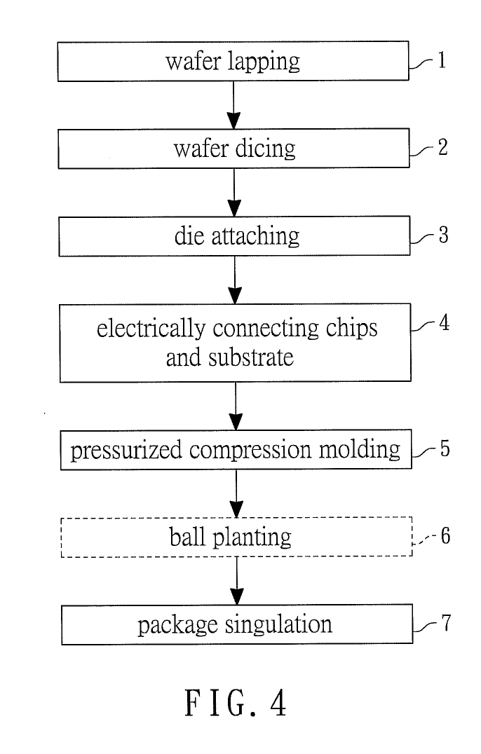

The major block diagram of a semiconductor packaging method including the compression molding method according to the present embodiment is shown in FIG. 4 which includes step 1 of “wafer lapping”, step 2 of “wafer dicing”, step 3 of “die attaching”, step 4 of “electrically connecting chips and substrate”, step 5 of “pressurized compression molding”, step 6 of “ball planting”, and step 7 of “package singulation” where step 6 is an optional step can be replaced or skipped according to different packaging types which does not affect the performance of the method described in the present embodiment. The compression molding method in the present invention can be implemented in step 5 which are described in detail from FIG. 1A to FIG. 1F or/and from FIG. 2A to FIG. 2D.

Firstly, step 1 is executed, a wafer includes a plurality of dice or chips where the base material of the wafer is a semiconductor material such as Si, SiGe, or GaAs. The wafer has an active surface on which IC are fabricated and a corresponding back surface. Before dicing, the wafer might be ground from the back surface by lapping equipment.

Then, step 2 is executed where the lapped wafer is diced into a plurality of individual chips 111 as shown in FIG. 1B by a dicing blade or by a laser cutter.

Then, step 3 is executed where die-attaching materials are firstly disposed on the die-attaching areas of the chip carriers such as the substrate 110 as described in FIG. 1B. The die-attaching material can be epoxy, silver paste, or double-sided film. Then, a chip suction nozzle picks up individual chips 111 from the diced wafer and disposed on the substrate 110.

Then, step 4 is executed where a plurality of metal wires electrically connect the chips 111 to the substrate 110 by a wire bonder. Without limitation, besides wire bonding, the electrical connections between the chips 111 and the substrate 110 can be done by flip-chip bonding, lead bonding, or other well-known bonding methods.

Then, step 5 of is executed where the afore described encapsulating material 131 is formed on top of the substrate 110 to encapsulate the chips 111 by the method of compression molding to reduce voids in molding compounds of semiconductor packages described in the present invention. To be more specific, through a specific heating and pressurizing process sequence of curing molding compounds as a technical mean, a positive pressure greater than 1 atm is provided when a top mold 21 and a bottom mold 22 are placed in the pressure chamber 10 from filling to curing of the encapsulating material 131 to expel or reduce bubbles trapped in the encapsulating material to enhance product yield, reliability, and lifetime.

After curing of the encapsulating material 131, step 6 can be executed where a plurality of solder balls are placed on the bottom surface of the substrate 110 as external electrical connections.

Finally, step 7 is executed where the molding compound 132 formed from the encapsulating material 131 is singulated into a plurality of individual semiconductor packages. Through cross-sectional analysis, the numbers and dimensions of the bubbles trapped inside the molding compound 132 are effectively reduced compared to the conventional compression molding technology using vacuum.

The above description of embodiments of this invention is intended to be illustrative but not limited. Other embodiments of this invention will be obvious to those skilled in the art in view of the above disclosure which still will be covered by and within the scope of the present invention even with any modifications, equivalent variations, and adaptations.

What is claimed is:

1. A method of compression molding to reduce voids in molding compounds of semiconductor packages, comprising:
providing a compression mold jig set in a pressure chamber, the compression mold jig including a first top mold and a first bottom mold installed below the first top mold, wherein the first bottom mold has a first mold cavity;
loading a first substrate on the first top mold, wherein a plurality of first chips are disposed on and electrically connected to the first substrate;
filling a first encapsulating material into the first mold cavity;
providing a positive air pressure greater than 1 atm in the pressure chamber and heating the first bottom mold to melt the first encapsulating material until expelling or reducing potential bubble trapped inside the first encapsulating material; and
pressing down the first top mold under the heating and continuously pressurizing condition until the first encapsulating material encapsulates the first chips and physically adheres to the first substrate and the first encapsulating material is pre-cured into a molding compound adhered to the first substrate.

2. The method as claimed in claim 1, wherein the positive air pressure in the pressure chamber ranges between 1 atm to 8 atm and the pressure chamber is continuously pressurized and exhausted.

3. The method as claimed in claim 1, wherein the first encapsulating material at the filling step has a form selected from one of the group consisting of powder, pellet, and film.

4. The method as claimed in claim 1, wherein the first top mold has a sealing ring aligned around the first mold cavity.

5. The method as claimed in claim 1, further comprising the step of unloading the first substrate from the first top mold after the formation of the molding compound.

6. The method as claimed in claim 5, wherein the compression mold jig set further includes a second top mold and a second bottom mold installed below the second top mold, wherein the second bottom mold has a second mold cavity, the method further comprising the step of:
providing an interchangeable double loading/unloading carrier;
loading a second substrate on the second top mold from the interchangeable double loading/unloading carrier during the formation of the molding compound;
filling a second encapsulating material into the second mold cavity;
heating the second bottom mold to melt the second encapsulating material under the heating and continuously pressurizing condition until expelling or reducing potential bubble trapped inside the second encapsulating material during unloading the first substrate; and
pressing down the second top mold until the second encapsulating material is pre-cured, meanwhile, loading a third substrate on the first top mold from the interchangeable double loading/unloading carrier after unloading the first substrate.

7. A compression molding apparatus to reduce voids in molding compounds of semiconductor packages, comprising:
a pressure chamber;
a compression mold jig set disposed inside the pressure chamber, the compression mold jig set including a first top mold for loading a first substrate and a first bottom mold installed below the first top mold, wherein the first bottom mold has a first mold cavity for filling a first encapsulating material;
wherein the pressure chamber provides a positive air pressure greater than 1 atm during pre-curing the first encapsulating material in a manner that potential bubble trapped inside the first encapsulating material is expelled or reduced.

8. The apparatus as claimed in claim 7, wherein the pressure chamber has a pressure inlet and an exhaust outlet for continuously pressurizing and exhausting when the positive air pressure is kept between 1 atm to 8 atm.

9. The apparatus as claimed in claim 7, further comprising an interchangeable double loading/unloading carrier for loading and unloading the first substrate and a second substrate, the compression mold jig set further including a second top mold for loading the second substrate from the interchangeable double loading/unloading carrier and a second bottom mold installed below the second top mold, wherein the second bottom mold has a second mold cavity for filling a second encapsulating material, and the loading/unloading motions of the first top mold and the second top mold are asynchronous.

10. The apparatus as claimed in claim 7, the first top mold has a sealing ring aligned around the first mold cavity.
